(19) United States
(12) Patent Application Publication
(10) Pub. No.: US 2008/0174798 A1
(43) Pub. Date: Jul. 24, 2008

(54) Color-management apparatus and method

(75) Inventors: Min-ki Cho, Seoul (KR); Ronnier Luo, Seoul (KR); Heui-keun Choh, Seoul (KR); Byoung-ho Kang, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/905,964

(22) Filed: Oct. 5, 2007

(30) Foreign Application Priority Data
Jan. 24, 2007 (KR) 10-2007-0007602

(51) Int. Cl. G06F 15/00

(52) U.S. Cl. 358/1.9

(57) ABSTRACT

A color-management apparatus and method which can improve color reproducibility during color-gamut mapping of devices having different color gamuts are provided. The apparatus includes a transformation unit transforming a first color space of an original image supplied from a source device into a second color space, a computing unit computing a plurality of second parameters based on at least one among a plurality of first parameter defining the second color space, and a color-gamut mapping unit performing color-gamut mapping between the source device and a reproduction device reproducing an output image from the original image using the plurality of second parameters.

### CROSS-REFERENCE TO RELATED APPLICATION

This application claims priority from Korean Patent Application No. 10-2007-0007602 filed on Jan. 24, 2007 in the Korean Intellectual Property Office, the disclosure of which is incorporated herein by reference in its entirety.

### BACKGROUND OF THE INVENTION

1. Field of the Invention

The present invention relates to an apparatus and method for providing color management. More particularly, the present invention relates to a color-management apparatus and method for providing improved color reproducibility in connection with color-gamut mapping between devices having different color gamuts by performing the color-gamut mapping using highly recognizable colors.

2. Description of the Related Art

In general, a color input/output device, such as a monitor, a scanner, a camera, or a printer, which reproduces colors, uses different color spaces or models. For example, a color printer uses the CMY or CMYK color space, while a color CRT monitor or computer graphics device uses the RGB color space. In order to define device dependent colors, which can be accurately reproduced independent of devices, CIE color spaces, typically CIE-XYZ, CIE-Lab, CIE-Luv, and the like, may be used.

In addition to these color spaces, color reproduction ranges, that is, color gamuts, vary greatly from one kind of device to another. Due to such a difference in color gamuts, it has been physically difficult to reproduce the same color on different kinds of devices. Thus, when color gamuts are different, color-gamut mapping for enhancing color reproducibility is needed by appropriately transforming input color signals of color gamuts for realizing color matching between the color input/output devices.

For example, for color-gamut mapping between a display and a color printer, the International Color Consortium (ICC), which is the color management standard organization, defines various methods for color-gamut mapping according to rendering intents. For color-gamut mapping of relative colormetric intent and Perceptual intent, the ICC recommended HPMINDE (Hue Preserved Minimum Delta E) and SGCK (Sigmoidal Gaussian luminance mapping, Cusp & Knee), respectively.

However, these methods have several limitations; smooth color reproduction cannot be achieved or color image distortion may result.

### SUMMARY OF THE INVENTION

The present invention provides a color-management apparatus and method for providing improved color reproducibility in color-gamut mapping between devices having different color gamuts.

The above and other objects of the present invention will be described in or be apparent from the following description of the preferred embodiments.

According to an aspect of the present invention, there is provided a color-management apparatus including a transformation unit transforming a first color space of an original image supplied from a source device into a second color space, a computing unit computing a plurality of second parameters based on at least one among a plurality of first parameter defining the second color space, and a color-gamut mapping unit performing color-gamut mapping between the source device and a reproduction device reproducing an output image from the original image using the plurality of second parameters.

According to another aspect of the present invention, there is provided a color management method including transforming a first color space of an original image supplied from a source device into a second color space, computing a plurality of second parameters based on at least one among a plurality of first parameter defining the second color space, and performing color-gamut mapping between the source device and a reproduction device reproducing an output image from the original image using the plurality of second parameters.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other features and advantages of the present invention will become apparent by describing in detail preferred embodiments thereof with reference to the attached drawings in which:

FIG. 1 is a schematic diagram of a color-management system according to an embodiment of the present invention;

FIG. 2 is a block diagram of a color-management apparatus according to an embodiment of the present invention;

FIG. 3 is an exemplary look-up table (LUT) according to an embodiment of the present invention;

FIG. 4 illustrates a generation procedure of the LUT shown in FIG. 3;

FIG. 5 illustrates color gamuts of a source device and a reproduction device in the [Jn, an, bn] space according to an embodiment of the present invention;

FIG. 6 is a diagram for explaining a visual perception test according an embodiment of the present invention; and

FIG. 7 is a flow chart illustrating a color management method according an embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of methods according to exemplary embodiments of the invention. It should be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to create means for implementing the functions specified in the flowchart block or blocks.

These computer program instructions may also be stored in a computer-usable or computer-readable memory that can direct a computer or other programmable data processing apparatus to function in a particular manner, such that the instructions implement the function specified in the flowchart block or blocks.

The computer program instructions may also be loaded into a computer or other programmable data processing apparatus to cause a series of operational steps to be performed in the computer or other programmable apparatus to produce a computer implemented process for implementing the functions specified in the flowchart block or blocks.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software. For example, two blocks shown in succession may, in fact, be executed substantially concurrently, or the blocks may sometimes be executed in reverse order, depending on the functionality involved.

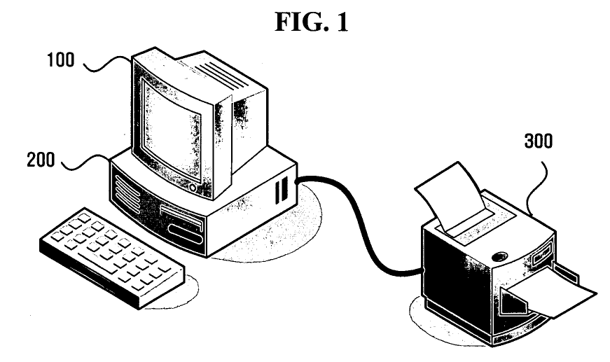

FIG. 1 is a schematic diagram of a color-management system according to an embodiment of the present invention. As shown in FIG. 1, the color-management system includes a source device 100, a color-management apparatus 200, and a color reproduction device.

The source device 100 displays an original image in an RGB signal format and supplies the original image to a color-management apparatus 200 (described later). Examples of the source device 100 include display devices such as a monitor, and the display devices may be LCD, PDP, LED, OLED, or Flexible displays, or the like. In the following, the invention will be described with regard to a display monitor using an sRGB color space as the source device 100.

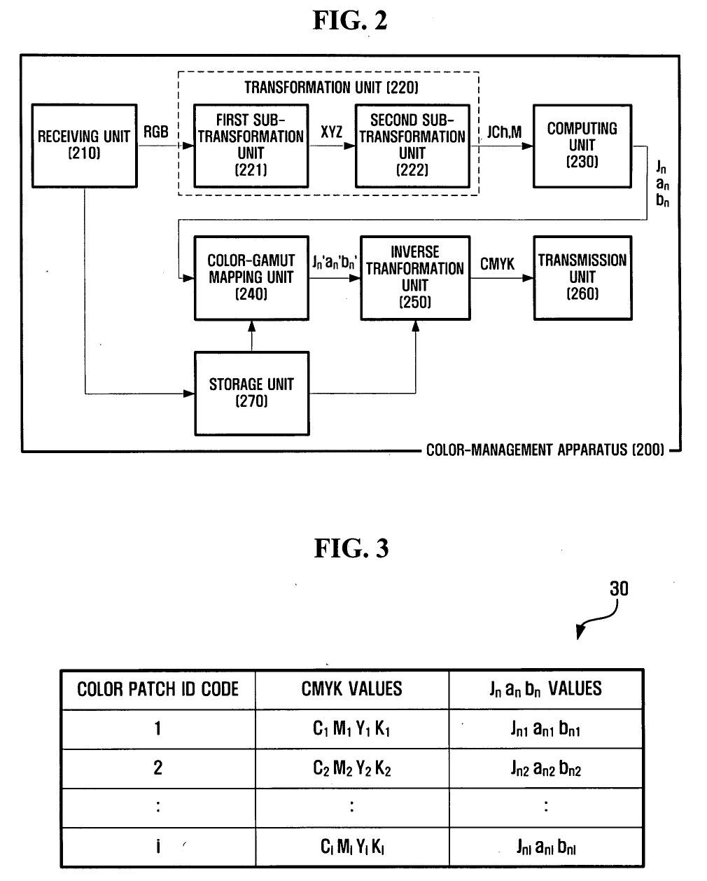

The color-management apparatus 200 transforms the RGB signal format original image supplied from the source device into a CIECAM02 format signal, and performs color-gamut mapping between the source device and the reproduction device using a plurality of second parameters computed based on at least one among a plurality of first parameters defining CIECAM02. As a result of the color-gamut mapping, an output image corresponding to the original image is generated. The color-management apparatus 200 will later be described in greater detail with reference to FIG. 2.

The reproduction device 300 receives the output image from the color-management apparatus 200 and reproduces an image. Examples of the reproduction device 300 include color digital media such as a printer, a multi-functional display, or the like. The reproduction device 300 employs wireless or wired communication media for data transmission with the color-management apparatus 200. In the following, the invention will be described with regard to a printer using a CMYK color space as the reproduction device 300.

FIG. 2 is a block diagram of a color-management apparatus 200 according to an embodiment of the present invention.

As shown in FIG. 2, the color-management apparatus 200 includes a receiving unit 210, a storage unit 270, a transformation unit 220, a computing unit 230, a color-gamut mapping unit 240, an inverse transformation unit 250 and a transmission unit 260.

The receiving unit 210 receives information regarding color gamuts of the source device 100 and the reproduction device 300, as received from the source device 100 and the reproduction device 300. In addition, the receiving unit 210 receives the original image in the RGB signal format from the source device 100.

The storage unit 270 stores color gamut information of the source device 100, color gamut information of the reproduction device 300, and algorithms required for color-gamut mapping between the source device 100 and the reproduction device 300. In addition, the storage unit 270 stores a look-up table (LUT) 30 having color reproduction characteristics of the reproduction device 300 recorded therein, the RGB format original image received from the source device 100, and so on. The storage unit 270 may be implemented by at least one storage medium including, but not limited to, a nonvolatile memory device such as cache, Read Only Memory (ROM), Programmable ROM (PROM), Erasable Programmable ROM (EPROM), Electrically Erasable Programmable ROM (EEPROM), Flash memory; and a volatile memory device such as Random Access Memory (RAM) or a Hard Disk Drive (HDD).

The transformation unit 220 transforms the RGB format original image into a signal of a CIECAM02 (Colour Appearance Model 2002) format. To this end, the transformation unit 220 may include a first sub-transformation unit 221 and a second sub-transformation unit 222.

The first sub-transformation unit 221 transforms the RGB format original image into an XYZ format signal. For example, in the case where the color space of the source device 100 is sRGB (standard-RGB), the first sub-transformation unit 221 may perform color space transformation based on Equations 1 and 4. Specifically, when the RGB format original image is represented as 255 bits, the first sub-transformation unit 221 obtains R′, G′, and B′ by dividing R, G, and B by 255, respectively, as given in the Equation 1, and then obtains intermediate variables rR, rG, and rB using the Equation 2 or 3 according to whether the magnitudes of R′, G′, B′ are smaller than or identical to a predefined threshold value, i.e., 0.04045. Then, the first transformation unit 220 transforms an RGB color space value into an XYZ color space value using Equation (4).

$$\begin{matrix}{R}^{′} = \frac{{R}_{8 bit}}{255} , {G}^{′} = \frac{{G}_{8 bit}}{255} , {B}^{′} = \frac{{B}_{8 bit}}{255} & Equation ( 1 ) \\ If {R}^{′} , {G}^{′} , {B}^{′} \leq 0.04045 \\ rR = \frac{{R}^{′}}{12.92} , rG = \frac{{G}^{′}}{12.92} , rB = \frac{{B}^{′}}{12.92} & Equation ( 2 ) \\ If {R}^{′} , {G}^{′} , {B}^{′ } 〉 0.04045 \\ rR = {( \frac{{R}^{′} + 0.055}{1.055} )}^{2.4} , rG = {( \frac{{G}^{′} + 0.055}{1.055} )}^{2.4} , \\ rB = {( \frac{{B}^{′} + 0.055}{1.055} )}^{2.4} & Equation ( 3 ) \\ [ \begin{matrix}X \\ Y \\ Z\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] [ \begin{matrix}rR \\ rG \\ rB\end{matrix} ] & Equation ( 4 )\end{matrix}$$

The second sub-transformation unit 222 receives the XYZ color space value from the first transformation unit 220 and transforms the same into a CIECAM02 color space value. The CIECAM02 (Colour Appearance Model 2002), which is a color appearance model created in 2004, allows a change in the color to be predicted by viewing conditions such as illumination sources or brightness. To effectuate the transforming into the CIECAM02 color space, in addition to the XYZ value of the original image, a plurality of input parameters are necessary.

Specific examples of the input parameters include tristimulus (CIEXYZ) values of reference white, i.e., X_{W}, Y_{W}, and Z_{W}, tristimulus values of reference white in reference condition, i.e., X_{wr}=100, Y_{wr}=100, and Z_{wr}=100, luminance of adapting field, i.e., L_{A}, background luminance factor, i.e., Y_{b}, viewing condition parameters, and background parameters. Examples of the background parameter include a background brightness induction factor (N_{bb}), a chromatic brightness induction factor (N_{cb}), and the like. Examples of the viewing condition parameter include impact of surround constant (c), a factor for degree of adaptation (F), a chromatic induction factor (N_{c}), and the like. The respective viewing condition parameter values are classified according to the surrounds as shown in Table 1 and can then be stored in the storage unit 270.

TABLE 1
Viewing condition parameters for different surrounds.

| Surround | F | c | N_{C} |
|---|---|---|---|
| Average | 1.0 | 0.69 | 1.0 |
| Dim | 0.9 | 0.59 | 0.95 |
| Dark | 0.8 | 0.525 | 0.8 |

Based on the above-described input parameters, the process of transforming the XYZ color space values into the CIECAM02 color space values is described in [Nathan Moroney, Mark Fairchild, Robert Hunt, Changjun Li, Ronnier Luo and Todd Newman, The CIECAM02 Color Appearance Model, IS&T/SID 10^{th} Color Imaging Conference] and a detailed explanation will not be given herein.

If the transformation from the XYZ color space into the CIECAM02 color space is completed, the original image can be represented by a plurality of first parameters defining the CIECAM02 color space, that is, lightness (J), chroma (C), hue angle (h), colorfulness (M), and so on, of the original image.

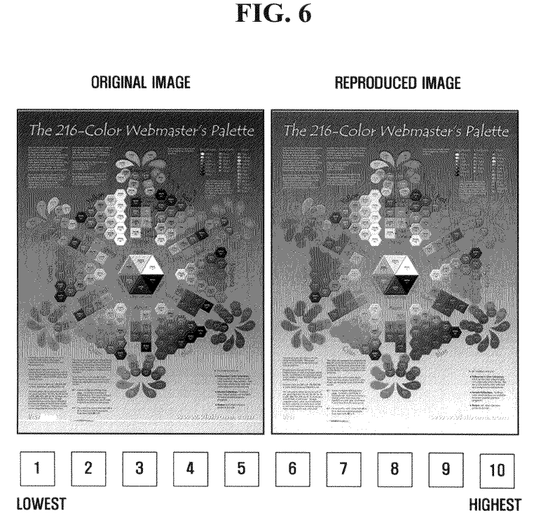

The computing unit 230 receives the plurality of first parameters from the second transformation unit 220, and computes a plurality of second parameters needed for color-gamut mapping between the source device 100 and the reproduction device 300. The second parameters include, for example, Jₙ, aₙ, and bₙ, which can be defined using Equation (5):

$${J}_{n} = \frac{{c}_{2} J}{{c}_{1} J} \\ {a}_{n} = {M}^{′} cos ( h ) \\ {b}_{n} = {M}^{′} sin ( h ) \\ {M}^{′} = ( {c}_{3} ) ln ( 1 + {c}_{4} M ) \qquad Equation ( 5 )$$

where c₁, c₂, c₃ and c₄ are constants that may be determined experimentally, which will later be described in the following with reference to FIG. 6.

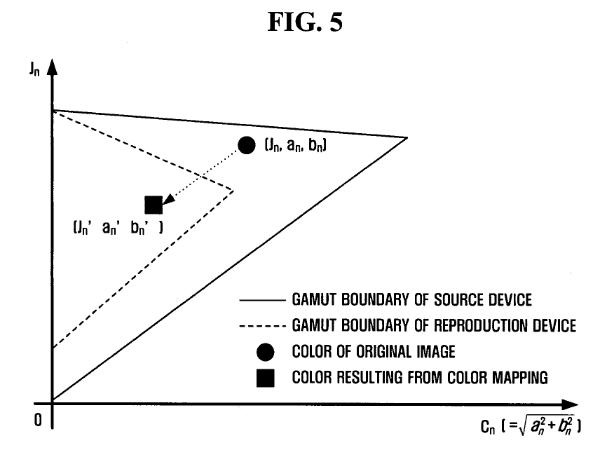

The color-gamut mapping unit 240 performs color-gamut mapping between the source device 100 and the reproduction. device 300 based on the second parameters computed using Equation (5). To this end, the color-gamut mapping unit 240 indicates color gamuts of the source device 100 and the reproduction device 300 on a space defined by Jₙ axis, aₙ axis and bₙ axis, as shown in FIG. 5. Then, the color-gamut mapping unit 240 computes a color difference (ΔEₙ) between a color contained in the original image and every color contained in the color gamut of the reproduction device 300 in a space defined by the Jₙ axis, aₙ axis and bₙ axis, and maps the color contained in the original image to a position where the computed color difference is the minimum. Here, an equation for computing the color difference (ΔEₙ) between a color contained in the original image and every color contained in the color gamut of the reproduction device 300 can be defined by Equation (6):

$$Δ {E}_{n} = \sqrt{{K ( {J}_{n}^{display} - {J}_{n}^{printer} )}^{2} + {( {a}_{n}^{display} - {a}_{n}^{printer} )}^{2} + {( {b}_{n}^{display} - {b}_{n}^{printer} )}^{2}}$$

where Jₙ^{display}, aₙ^{display} and bₙ^{display} indicate Jₙ, aₙ and bₙ values for colors contained in original images, Jₙ^{printer}, aₙ^{printer} and bₙ^{printer} are Jₙ, aₙ and bₙ values for colors contained in the color gamut of the reproduction device 300, and K is a constant that may be experimentally determined, which will later be described in the following with reference to FIG. 6.

The inverse transformation unit 250 transforms coordinates Jₙ′, aₙ′ and bₙ′ of a mapped point of the color of the original image into values of a color space used by the reproduction device 300, that is, the CMYK color space. For this purpose, the inverse transformation unit 250 may refer to a look-up table (LUT) 30 having color reproduction-characteristics of the reproduction device 300 recorded therein. The LUT 30 will now be described with reference to FIG. 3.

FIG. 3 is an exemplary look-up table (LUT) according to an embodiment of the present invention.

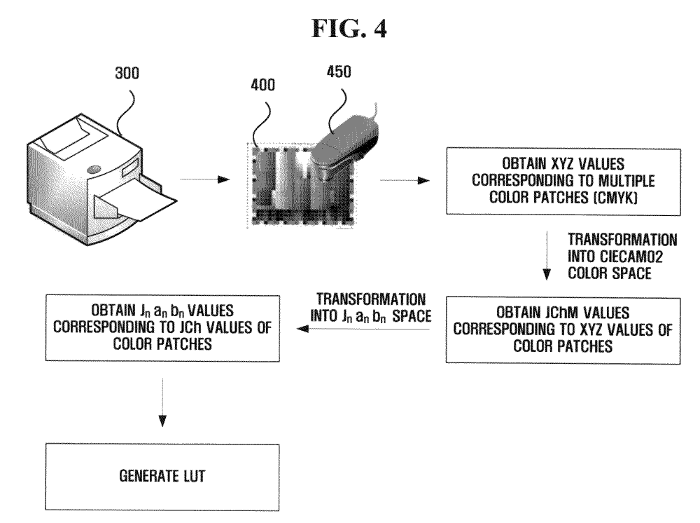

As shown in FIG. 3, the LUT 30 includes standard calibration values of color patches reproduced by the reproduction device 300, and a plurality of second parameters corresponding to the standard calibration values. A procedure of generating the LUT 30 will briefly be described with reference to FIG. 4.

FIG. 4 illustrates a generation procedure of the LUT shown in FIG. 3.

First, a source image including a plurality of color patches is reproduced by a reproduction device 300. Next, the respective color patches of the reproduced image 400 are subjected to color calibration by means of a calorimeter 450 to obtain standard calibration values, e.g., CIEXYZ color space values (for example, X, Y, and Z values for CIEXYZ color space). Thereafter, the standard calibration values are transformed into CIECAM02 color space values, and values of the first parameters J, C, h, and M are obtained using Equation (5) to obtain the second parameters Jₙ, aₙ and bₙ. Thereafter, the standard calibration values and Jₙ, aₙ and bₙ corresponding to the standard calibration values are arranged by a color patch, thereby generating the LUT 30 shown in FIG. 3. The generation of the LUT 30 may be performed by either the color-management apparatus 200 or the reproduction device 300. In a case where the LUT 30 is generated by the reproduction device 300, the color-management apparatus 200 may receive the LUT 30 from the reproduction device 300 via the receiving unit 210.

Referring again to FIG. 2, the inverse transformation unit 250 transforms coordinates (Jₙ′, aₙ′, bₙ′) in a color space, i.e., a CMYK color space, used by the reproduction device by referring to the LUT 30 shown in FIG. 3. To this end, the inverse transformation unit 250 searches the LUT 30 to determine whether there are coordinates identical to (Jₙ′, aₙ′, bₙ′) in the LUT 30.

If it is determined that there are coordinates identical to (Jₙ′, aₙ′, bₙ′), the inverse transformation unit 250 selects the standard calibration values corresponding to the coordinates. Then, the inverse transformation unit 250 performs inverse transformation on the selected standard calibration values to obtain CMYK values. That is to say, the inverse transformation unit 250 transforms the selected standard calibration values into RGB values to then transform the RGB values into CMYK values. Since the transformation from XYZ to RGB and transformation from RGB to CMYK are well known in the art, a detailed explanation thereof will not be given.

In contrast, if it is determined that there are no coordinates identical to (Jₙ′, aₙ′, bₙ′), the inverse transformation unit 250 predicts the standard calibration values corresponding to the coordinates by referring to the LUT 30 shown in FIG. 3. Next, the inverse transformation unit 250 transforms the predicted standard calibration values into RGB values and then transforms the RGB values into CMYK values to generate an output image in a CMYK format. The CMYK format output image is supplied to the reproduction device 300 through the transmission unit 260.

A method of determining the constants c₁, c₂, c₃, and c₄ in Equation (5) and the constant K in Equation (6) is described with reference to FIG. 6 in the following.

First, the constants c₁, c₂, c₃, c₃ and K are set to arbitrary numbers, and a predetermined original image is transformed so as to have a CMYK format to obtain an output image corresponding to the original image. In addition, an output image having a CMYK format is reproduced in the reproduction device 300. Here, the output image corresponding to the original image and the output image reproduced in the reproduction device 300 are substantially similar, but in the following description, the latter image is to be referred to as a “reproduced image” for a better understanding of the invention. Once a reproduced image for the original image is generated, the constants c₁, c₂, c₃, c₃ and K are set differently from previous values, and then the above-described procedures are repeated, thereby obtaining different N reproduced images for the original image (N≧1).

Next, as shown in FIG. 6, the original image and the reproduced image displayed by the source device 100 are placed side by side for evaluation of visual perceptibility testing to multiple test groups. In the visual perceptibility test, test groups are allowed to compare an original image with a reproduced image, and satisfaction for color reproducibility of the reproduced image is rated in scales ranging, e.g., from 1 to 10 points. That is to say, as a result of comparison, the closer to the color of original image the color of the reproduced image was, the higher scale was assessed. The visual perceptibility tests were performed on N reproduced images, giving results shown in Table 2.

TABLE 2
Result of visual perceptibility test.

| Reproduced image | Scales |
|---|---|
| First reproduced image | 5 |
| . | . |
| . | . |
| . | . |
| The Nth reproduced image | 8 |

If the visual perceptibility tests are finished, values of the constants c₁, c₂, c₃, c₃ and K are determined based on visual perceptibility scales shown in Table 2 and the color difference (ΔEₙ) in Equation (6). That is to say, the values of the constants c₁, c₂, c₃, c₃ and K are determined such that the higher the visual perceptibility scales shown in Table 2, the smaller the color difference (ΔEₙ) in Equation (6).

The above-described tests may be performed on various kinds of original images, for example, LCD (Large Color difference Data) such as OSA, BFDB, Guan, Munsell, Zhu, or Pointer; SCD (Small Color difference Data) such as BFD, TIT-Dupont, Leeds, or Witt; and UCS (Uniform Color Space). Table 3 shows the values of the constants c₁, c₂, c₃, c₃ and K determined according to the test results after performing the visual perceptibility tests on LCD, SCD and UCS.

TABLE 3
Values of the constant c₁, c₂, c₃, c₃ and K

| Constant | LCD | SCD | UCS |
|---|---|---|---|
| K | 1.3 | 0.81 | 1 |
| c₁ | 0.007 | 0.007 | 0.007 |
| c₂ | 0.7 | 0.7 | 0.7 |
| c₃ | 189 | 28 | 44 |
| c₄ | 0.0053 | 0.0363 | 0.0228 |

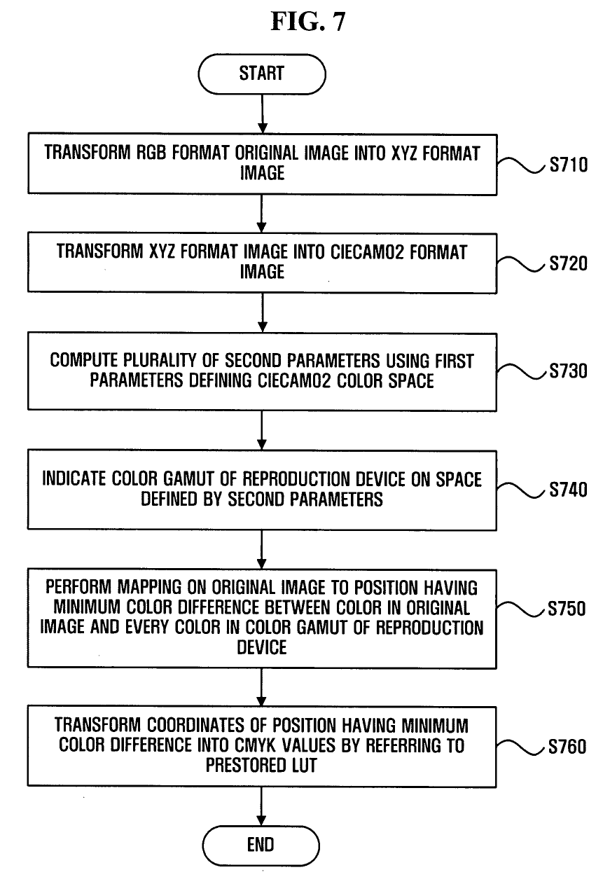

Next, a color management method according an embodiment of the present invention will be described with reference to FIG. 7.

FIG. 7 is a flow chart illustrating a color management method according an embodiment of the present invention.

First, if an RGB format original image received from a source device 100, the RGB format original image is transformed into the XYZ format image in step S710.

Next, the XYZ format original image is transformed into an image in a CIECAM02 format in step S720. Here, the CIECAM02 format is defined by a plurality of first parameters J, C, h and M. If the transformation into the CIECAM02 format, the J, C, h and M values for the original image can be obtained. Thereafter, using Equation (5), a plurality of second parameters Jₙ, aₙ and bₙ needed for color-gamut mapping between a source device and a reproduction device are computed from the plurality of first parameters for the original image in step S730.

Next, a color gamut of the reproduction device 300 is indicated on a space defined by the second parameters in step S740. The color difference (ΔEₙ) between a color contained in the original image and every color contained in the color gamut of the reproduction device 300 is computed using Equation (6). In step S750, the color of the original image is mapped to a position where the computed color difference (ΔEₙ) is the minimum.

As shown in FIG. 3, in step S760, the coordinates where the color difference is a minimum are transformed into CMYK values, that is, a color space used by the reproduction device, by referring to an LUT having color reproduction characteristics of the reproduction device 300. In detail, the LUT is searched and it is determined whether there are coordinates identical to coordinates of a position where the color difference is a minimum.

If yes, the standard calibration values corresponding to the coordinates are selected. For example, if the coordinates of a position where the color difference is the minimum are (Jₙ₁, aₙ₁, bₙ₁), the standard calibration values (C₁, M₁, Y₁, K₁) are selected.

If there are no coordinates identical to coordinates of a position where the color difference is the minimum, the standard calibration values corresponding to the coordinates of a point where the color difference is the minimum are predicted by referring to the LUT.

The predicted standard calibration values are transformed into RGB values and then the RGB values are transformed into CMYK values to generate a CMYK format output image, which is then supplied to the reproduction device 300 through a transmission unit 260.

In the foregoing description, the present invention has been described with regard to the color-management apparatus 200 transforming RGB format original image into a CIECAM02 color space value to obtain Jₙ, aₙ and cₙ values and performing color-gamut mapping using the predefined equation for color difference.

Meanwhile, a color-management apparatus (not shown) according another embodiment of the present invention performs color-gamut mapping on a reference image including a plurality of color patches using Equation (6) to then generate an LUT containing color-gamut mapping results. Then, an output image corresponding to a predetermined original image may be generated by referring to the generated LUT.

In detail, color-gamut mapping is performed on the reference image including a plurality of color patches using Equation (6) to obtain RGB values for the respective color patches. Then, the RGB values for the respective color patches and an LUT including Jₙ, aₙ, and bₙ values corresponding to the RGB values for the color patches are generated and stored. Thereafter, upon receiving the original image from the source device, Jₙ, aₙ, and bₙ values corresponding to the RGB values of the original image are predicted by referring to the LUT. Next, XYZ values corresponding to the predicted Jₙ, aₙ, and bₙ values are detected by referring to the LUT having the color reproduction characteristics of the reproduction device recorded therein. Then, the detected XYZ values are inversely transformed to generate CMYK values, thereby obtaining an output image in CMYK format, corresponding to the original image. The color-management apparatus may be implemented independently of the source device 100 and the reproduction device 300, or may be implemented with either the source device 100 or the reproduction device 300 in a hardware or software manner.

As described above, in the color-management apparatus and method according to the present invention, color-gamut mapping is performed between devices having different color gamuts using color space models that are uniformly perceived, thereby achieving improved color reproducibility of an output image corresponding to an original image.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

1. A color-management apparatus comprising:
a transformation unit transforming a first color space of an original image supplied from a source device into a second color space;
a computing unit computing a plurality of second parameters based on at least one among a plurality of first parameter defining the second color space; and
a color-gamut mapping unit performing color-gamut mapping between the source device and a reproduction device reproducing an output image from the original image using the plurality of second parameters.

2. The color-management apparatus of claim 1, wherein the first color space is an RGB color space and the second color space is a CIECAM02 color space.

3. The color-management apparatus of claim 2, wherein the transformation unit comprises:
a first sub-transformation unit transforming the RGB color space into an XYZ color space; and
a second sub-transformation unit transforming the XYZ color space into the CIECAM02 color space.

4. The color-management apparatus of claim 2, wherein the plurality of first parameters include J representing lightness, C representing chroma, h representing hue angle, and M representing colorfulness.

5. The color-management apparatus of claim 4, wherein the plurality of second parameters include Jₙ, aₙ, and bₙ, where
Jₙ=c₂J/c₁J,
aₙ=M′ cos(h),
bₙ=M′ cos(h),
M′=c₃ ln(1+c₄M)
and c₁, c₂, c₃, and c₄ are constants.

6. The color-management apparatus of claim 5, wherein the color-gamut mapping unit computes a color difference between a first color contained in the original image and a second color contained in the color gamut of the reproduction device in a space defined by the Jₙ axis, aₙ axis and bₙ axis, and maps the first color to a position where the computed color difference is a minimum.

7. The color-management apparatus of claim 6, wherein the color difference is defined by:
$$\sqrt{{K ( {J}_{n}^{display} - {J}_{n}^{printer} )}^{2} + {( {a}_{n}^{display} - {a}_{n}^{printer} )}^{2} + {( {b}_{n}^{display} - {b}_{n}^{printer} )}^{2}}$$
where Jₙ^{display}, aₙ^{display}, bₙ^{display} respectively denote Jₙ-axis, aₙ-axis and bₙ-axis coordinates of the original image, Jₙ^{printer}, aₙ^{printer}, bₙ^{printer} respectively denote Jₙ-axis, aₙ-axis and bₙ-axis coordinates of the second color, and K is a constant.

8. The color-management apparatus of claim 6, further comprising an inverse transformation unit inversely transforming Jₙ, aₙ, and bₙ values where the color difference is a minimum into values of a third color space that is a color space of the reproduction device by referring to a look-up table (LUT) having color reproduction characteristics of the reproduction device.

9. The color-management apparatus of claim 8, wherein the third color space is a CMYK color space.

10. The color-management apparatus of claim 8, wherein the LUT includes standard calibration values for a plurality of color patches reproduced by the reproduction device, and Jₙ, aₙ, and bₙ values corresponding to the standard calibration values.

11. A color management method comprising:
transforming a first color space of an original image supplied from a source device into a second color space;
computing a plurality of second parameters based on at least one among a plurality of first parameters defining the second color space; and
performing color-gamut mapping between the source device and a reproduction device reproducing an output image from the original image using the plurality of second parameters.

12. The color management method of claim 11, wherein the first color space is an RGB color space and the second color space is a CIECAM02 color space.

13. The color management method of claim 11, wherein the transforming of the first color space of the original image comprises:
transforming the RGB color space into an XYZ color space; and
transforming the XYZ color space into the CIECAM02 color space.

14. The color management method of claim 12, wherein the plurality of first parameters include J representing lightness, C representing chroma, h representing hue angle, and M representing colorfulness.

15. The color management method of claim 14, wherein the plurality of second parameters include Jₙ, aₙ, and bₙ, where
Jₙ=c₂J/c₁J,
aₙ=M′ cos(h),
bₙ=M′ cos(h),
M′=c₃ ln(1+c₄M)
and c₁, c₂, c₃, and c₄ are constants.

16. The color management method of claim 15, wherein the performing of the color-gamut mapping comprises computing a color difference between a first color contained in the original image and a second color contained in the color gamut of the reproduction device in a space defined by the Jₙ axis, aₙ axis and bₙ axis, and mapping the first color to a position where the computed color difference is a minimum.

17. The color management method of claim 16, wherein the color difference is defined by:
$$\sqrt{{K ( {J}_{n}^{display} - {J}_{n}^{printer} )}^{2} + {( {a}_{n}^{display} - {a}_{n}^{printer} )}^{2} + {( {b}_{n}^{display} - {b}_{n}^{printer} )}^{2}}$$
where Jₙ^{display}, aₙ^{display}, bₙ^{display} respectively denote Jₙ-axis, aₙ-axis and bₙ-axis coordinates of the original image, Jₙ^{printer}, aₙ^{printer}, bₙ^{printer} respectively denote Jₙ-axis, aₙ-axis and bₙ-axis coordinates of the second color, and K is a constant.

18. The color management method of claim 6, further comprising inversely transforming Jₙ, aₙ, and bₙ values where the color difference is the minimum into values of a third color space that is a color space of the reproduction device by referring to a look-up table (LUT) having color reproduction characteristics of the reproduction device.

19. The color management method of claim 18, wherein the third color space is a CMYK color space.

20. The color management method of claim 18, wherein the LUT includes standard calibration values for a plurality of color patches reproduced by the reproduction device, and Jₙ, aₙ, and bₙ values corresponding to the standard calibration values.
